(19) United States
(12) Patent Application Publication
(10) Pub. No.: US 2012/0035955 A1
(43) Pub. Date: Feb. 9, 2012

(54) CARE SERVICE MANAGEMENT SYSTEM AND METHOD THEREOF

(75) Inventors: Jung-Woung KIM, Yongin-Si (KR); Hyoung-Kyu CHOI, Seoul (KR); Young-Ju KIM, Gwangju (KR)

(73) Assignee: KWANGJU INFORMATION SERVICE CENTER, Gwangju (KR)

(21) Appl. No.: 12/938,598

(22) Filed: Nov. 3, 2010

(30) Foreign Application Priority Data
Aug. 3, 2010 (KR) 2010-0075056

(51) Int. Cl. G06Q 50/00; G06Q 10/00

(52) U.S. Cl. 705/3; 705/2

(57) ABSTRACT

Disclosed are a care service management system and a method thereof enabling services such as care service requesting, care service recording, and the like which have been performed off line in the past to be processed online in real time and in addition, providing learning contents of a care provider. The care service management system for a care service provider and a cared person, comprises a care service management server inputting and storing a cared person information DB, a care service provider information DB, a cared person schedule DB, a care service provider schedule DB, and a charge information DB; a health condition management server inputting and storing health information for each hour/date of the cared person; a learning content management server inputting and storing learning contents of the care service provider; a cared person's terminal connected with the care service management server to request for providing the care service and receive the determined information and schedule of the care service provider; and a care service provider's terminal connected with the care service management server, the health condition management server, or the learning contents management server to transmit or receive predetermined information.

### RELATED APPLICATIONS

This application claims priority from Korean Patent Application No. 2010-0075056, filed on Aug. 3, 2010 in the Korean Intellectual Property Office, the entire disclosure of which is incorporated herein by reference.

### BACKGROUND OF THE INVENTION

1. Field of the Invention

The present invention relates to a care service management system and a method thereof, and more particularly, to a care service management system and a method thereof enabling services such as care service requesting, care service recording, and the like which have been performed off line in the past to be processed online in real time and in addition, providing learning contents of a care provider.

2. Description of the Related Art

In recent years, the average life span has increased by various factors such as improvement of the standard of living, the advancement of medical technology, and the like and with an aging tendency of the entire society in addition to the decrease of fertility rate, the problems of the aged resulting from the aging society have largely come into the limelight. Further, as a by-product of the age of nuclear families resulting from the decrease of birth rates, senior citizens who live alone and cannot lead their own lives by themselves are being produced and care homes for them or systematic living protection by care providers is required.

In order to solve problems regarding old people or handicapped persons, care services are drawing public attention. In general, the care service as a kind of a social welfare service represents providing services such as nursing, housekeeping, accompanying visitation in a hospital, and the like to old people or handicapped persons who are ailing and cannot take care of activities by themselves.

The care service is in progress in a manner in which when old people or handicapped persons request predetermined services such as a visiting care service at a predetermined time, a nursing service, a bathing service, a housekeeping service, and the like to a care service providing institution, the care service providing institution sends out the care service provider who can provide the requested service to a request location at a requested time. Therefore, the care service provider provides the corresponding service as long as the first engagement time and thereafter, moves to a location where another service is requested to provide the corresponding service to another person.

In the prior art, when the care service provider records the care service in detail by handwriting and reports the care service details to a social worker, it is general to generate the reported care service details as a computer file by using a computer, and the like and request a charge of providing the care service. The care service details reporting and the charge requesting are complicated and inaccurate and cause the care service provider not to concentrate on providing the care service because persons should record the care service details and generate them as the file.

Further, in such a care service, since the schedule of the care service provider is generally designated in advance, a time which is usable at the time of providing the care service is limited. In contrast, when the care service provider who is requested to provide the housekeeping service visits the corresponding home, and the care service provider is requested to provide additional nursing or accompanying visitation to a hospital in addition to housekeeping services, the visiting care service provider cannot provide the additionally requested service due to the previously planned schedule.

Accordingly, there are required a care service management system and a method thereof that (i) allow cared persons such as old people to acquire systematic and efficient care protection management by the care service provider in their actual lives, (ii) relieve efforts of the care service provider to process miscellaneous administrative works, and (iii) allow the cared persons to easily request the care service and easily request the change of the care service.

### SUMMARY OF THE INVENTION

The present invention is contrived to solve the above-mentioned problems in the prior art and it is one object of the present invention to provide a care service management system that relieves efforts of administrative processing works of care service providers and ensures rapidity, accuracy, and convenience in providing a care service by processing all the care services online.

Further, it is another object of the present invention to provide a care service management system that can easily acquire information such as a health history of a cared person from a viewpoint of a care service provider, and the like, provide a high-quality care service by easily acquiring learning contents, and simply perform administrative processing such as charge computation, and the like.

In addition, it is the other object of the present invention to provide a care service management system that allows the cared person to acquire convenience to select and receive his/her desired care service provider and care service.

According to an aspect of the present invention, there is provided a care service management system for a care service provider and a cared person, comprising: a care service management server inputting and storing a cared person information DB, a care service provider information DB, a cared person schedule DB, a care service provider schedule DB, and a charge information DB; a health condition management server inputting and storing health information for each hour/date of the cared person; a learning content management server inputting and storing learning contents of the care service provider; a cared person's terminal connected with the care service management server to request for providing the care service and receive the determined information and schedule of the care service provider; and a care service provider's terminal connected with the care service management server, the health condition management server, or the learning contents management server to transmit or receive predetermined information.

Preferably, the system further comprises a simulation care level judgment server equipped with a simulation care level judgment module that judges a care level by inputting predetermined health information of the cared person.

Preferably, the cared person information DB includes an address, a telephone number, an e-mail address, and a disease history of the cared person.

Preferably, the care service management server includes a schedule matching module that matches a schedule when the cared person wants to be cared for and a schedule of the care service provider which the cared person requires.

Preferably, the care service management server includes a charge computing module that computes the charge on the basis of a care service providing time and a care service providing item that are provided to the cared person, which are transmitted from the care service provider's terminal.

Preferably, the care service management server includes a care management manual providing module that provides a care management manual required to provide the care service to the care service provider to the care service provider's terminal.

Preferably, the health condition management server provides a health condition management manual into which the health information for each hour and health information for each date of the cared person to the care service provider's terminal.

Preferably, the learning contents of the care service provider is at least one selected from a cared person play therapy content, cared person abuse prevention education contents, and care service provider continuing education contents.

Preferably, the care service provider's terminal is any one selected from a cellular phone, a smart phone, a portable multimedia player (PMP), a person digital assistant (PDA), and an electronic notebook which can transmit and receive data.

Preferably, information is inputted into the care service provider's terminal by using a digital pen.

According to another aspect of the present invention, there is provided a care service management method for a care service provider and a cared person, comprising: (a) allowing a cared person to input a care schedule which the cared person desires into a care service management server by using a cared person's terminal; (b) allowing a schedule matching module of the care service management server to transmit information on at least one care service provider having a schedule matching the care schedule which the cared person desires to the cared person's terminal; (c) allowing the cared person to select his/her desired care service provider from at least one care service provider; (d) allowing the care service management server to transmit the schedule of the cared person to a care service provider's terminal of a care service provider selected by the cared person; (e) allowing the care service provider receiving the schedule of the cared person to notify that the care service is providable in accordance with the schedule of the cared person to the care service management server; (f) allowing the care service management server to notify that the care service schedule is determined to the cared person's terminal; and (g) providing the care service by the care service provider.

Preferably, the method further comprises, after step (g), (h) allowing the care service provider to transmit a care service providing time and a care service providing item to the care service management server; and (i) allowing a charge computing module of the care service management server to compute a charge on the basis of the care service providing time and the care service providing item.

Preferably, the method further comprises, after step (f), (j) allowing the cared person to request for the change of the care service to the care service management server; (k) allowing the schedule matching module of the care service management server to transmit information on at least one care service provider which is suitable for the changed schedule to the cared person's terminal; (l) allowing the cared person to select his/her desired care service provider; (m) allowing the care service management server to transmit the schedule of the cared person to the care service provider's terminal; (n) allowing the care service provider receiving the schedule of the cared person to notify that the care service is providable in accordance with the schedule of the cared person to the care service management server; and (o) allowing the care service management server to notify that the schedule is determined to the cared person's terminal.

Preferably, at step (k), the schedule matching module complexly modifies schedules of a plurality of care service providers to form an optimal schedule of the care service provider and transmits the formed schedule to the cared person's terminal.

Preferably, at step (g), at least one content selected from a cared person play therapy content, a cared person abuse prevention education content, and a care service provider continuing education content included in a learning contents management server is provided to the care service provider's terminal.

Preferably, at step (g), a care management manual providing module of the care service management server provides a care management manual required to provide the care service to the care service provider's terminal.

Preferably, at step (g), a health condition management server provides a health condition management manual to input health information for each hour and health information for each date to the care service provider's terminal.

Preferably, the care service provider's terminal is any one selected from a cellular phone, a smart phone, a portable multimedia player (PMP), a personal digital assistant (PDA), and an electronic notebook which transmits and receives data.

Preferably, information is inputted into the care service provider's terminal by using a digital pen.

The present invention may include a computer-readable recording medium recording a computer program for executing a care service management method.

By the care service management system according to the present invention, it is possible to relieve efforts of administrative processing works of care service providers and ensure rapidity, accuracy, and convenience in providing a care service by processing all the care services online.

Further, according to the present invention, it is possible to easily acquire information such as a health history of a cared person, and the like, provide a high-quality care service by easily acquiring learning contents, and simply perform administrative processing such as charge computation, and the like.

In addition, according to the present invention, it is possible to allow the cared person to acquire convenience to select and receive his/her desired care service provider and care service and to change and receive the care service provider and care service in accordance with his/her schedule.

### BRIEF DESCRIPTION OF THE DRAWINGS

These and other objects, features, aspects, and advantages of the present invention will be more fully described in the following detailed description of preferred embodiments and examples, taken in conjunction with the accompanying drawings. In the drawings:

FIG. 1 is a flowchart of a care service in the prior art;

FIG. 2 is a flowchart of a care service according to an exemplary embodiment of the present invention;

FIG. 3 is a configuration diagram of a care service management system according to an exemplary embodiment of the present invention;

FIGS. 4 to 5 are exemplary diagrams of continuing education contents of care service providers according to an exemplary embodiment of the present invention;

FIG. 6 is an exemplary diagram of a care service provider's terminal and a digital pen according to an exemplary embodiment of the present invention;

FIGS. 7 to 12 are screen display diagrams of a care service provider's terminal according to an exemplary embodiment of the present invention;

FIGS. 13 to 16 are exemplary diagrams of contents provided by a care service management system according to an exemplary embodiment of the present invention; and

FIG. 17 is a flowchart of a care service management method according to an exemplary embodiment of the present invention.

### DETAILED DESCRIPTION OF THE INVENTION

Hereinafter, exemplary embodiments of the present invention will be described in detail with reference to the accompanying drawings.

Prior to this, terms or words used in the specification and claims should not be construed as limited to a lexical meaning, and should be understood as appropriate notions by the inventor based on that he/she is able to define terms to describe his/her invention in the best way to be seen by others. Therefore, embodiments and drawings described herein are simply exemplary and not exhaustive, and it will be understood that various modifications and equivalents may be made to take the place of the embodiments.

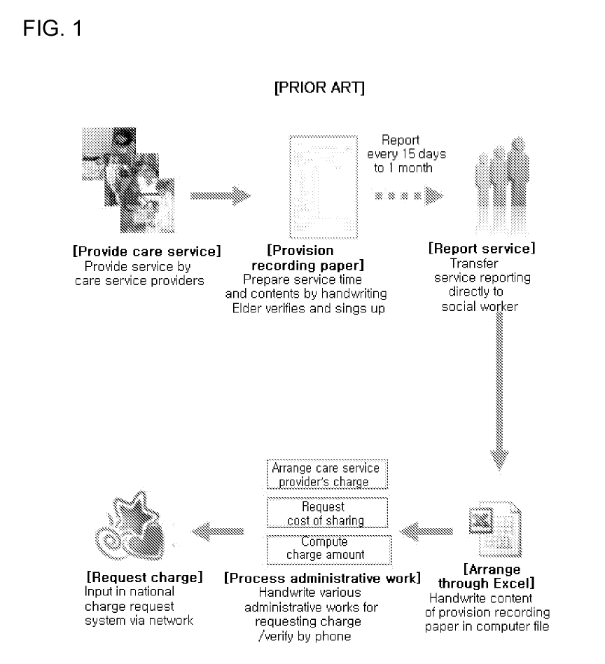

FIG. 1 is a flowchart of a care service in the prior art.

In the prior art, (1) care service providers provide care services and thereafter, (2) prepare a service time, a service content, and the like in provision recording paper by handwriting and (3) submit it directly to a care service institution including a social worker and the like.

(4) The received content of the provision recording paper is inputted into a computer file in a format such as an excel file, and the like by handwriting, (5) various administrative works for requesting a charge, such as the arrangement of wages of the care service providers, a request for cost of sharing, the computation of a charge amount, and the like are processed by handwriting and are verified by using a phone, and (6) an input operation into a predetermined charge request system by using a computer is performed.

Therefore, since a process of requesting the charge by inputting the service details in numerous provision recording papers by handwriting and generating the inputted service details as the computer file should be performed, a lot of time and effort is consumed at the time of managing the care service and requesting the charge.

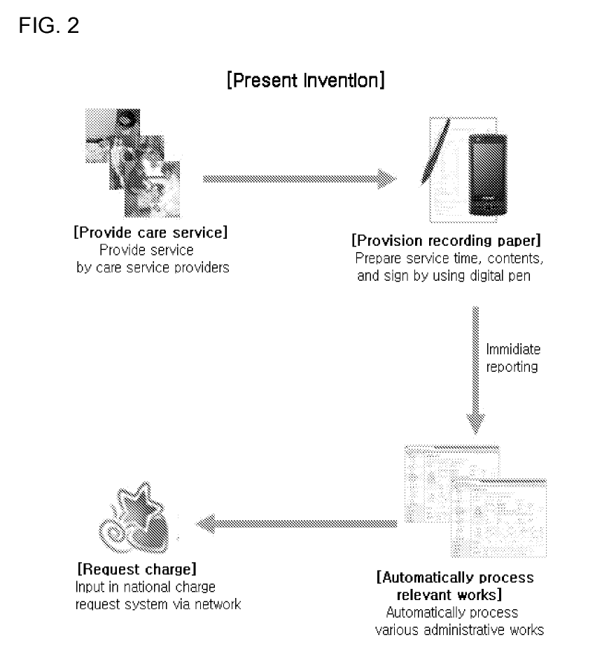

FIG. 2 is a flowchart of a care service according to an exemplary embodiment of the present invention.

In order to solve the problems in the prior art, according to the exemplary embodiment of the present invention, (1) care service providers provide care services, (2) transmit the care service and the care service contents to a care service management server of a care service institution in real time by using care service providers' terminals, (3) the care service management server automatically and rapidly processes various administrative works for requesting a charge, such as the arrangement of wages of the care service providers, a request for cost of sharing, and the computation of a charge amount, and (4) various administrative works are inputted into a predetermined charge requesting system through a computer, thereby ensuring the care service processing with rapidity, accuracy, and convenience.

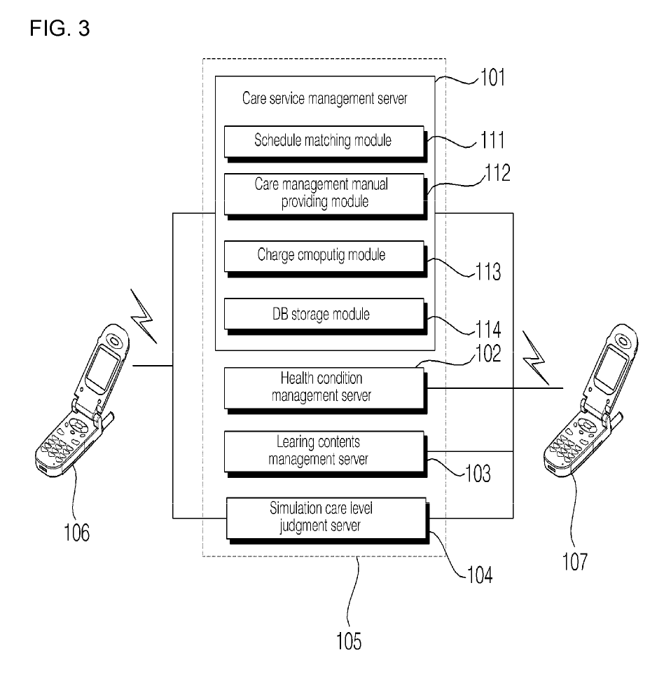

FIG. 3 is a configuration diagram of a care service management system according to an exemplary embodiment of the present invention.

The care service management system according to the exemplary embodiment of the present invention includes: a care service management server 101 inputting and storing a cared person information DB, a care service provider information DB, a cared person schedule DB, a care service provider schedule DB, and a charge information DB; a health condition management server 102 inputting and storing health information for each hour/date of the cared person; a learning content management server 103 inputting and storing learning contents of the care service provider; a cared person's terminal 106 connected with the care service management server to request for providing the care service and receive the determined information and schedule of the care service provider; and a care service provider's terminal 107 connected with the care service management server, the health condition management server, or the learning contents management server to transmit or receive predetermined information.

The system may include a simulation care level judgment server 104 equipped with a simulation care level judgment module that judges a care level by inputting predetermined health information of the cared person.

The care service management server 101, the health condition management server 102, the learning contents management server 103, and the simulation care level judgment server 104 are included in a central server 105 of a care service institution to constitute the care service management system.

The care service management server 101 inputs and stores the cared person information DB, the care service provider information DB, the cared person schedule DB, the care service provider schedule DB, and the charge information DB and serves to transmit and receive the DBs to and from the cared person's terminal 106 or the care service provider's terminal 107.

The cared person information DB may include a DB regarding an address, a telephone number, an e-mail address, and a disease history of a cared person and the care service provider receives the address, telephone number, and the like of the cared person to rapidly and accurately visit at a cared person's home. Further, the care service provider receives the disease history including a health history, and the like of the cared person through the care service provider's terminal 107 with a request to visit the cared person's home while preparing for an anticipated care service in advance.

The care service management server 101 may include a schedule matching module 111, a care management manual providing module 112, a charge computing module 113, and a DB storage module 114.

The schedule matching module 111 serves to match a schedule when the cared person wants to be cared for and a schedule of the care service provider which the cared person requires.

That is, when the cared person accesses the care service management server 101 to input a time and a location to be cared for by using his/her own cared person terminal 106, the schedule matching module 111 retrieves a plurality of care service providers who can provide the care service at the cared person's desired time and location and transmits information on the retrieval result to the cared person's terminal 106. The information on the care service provider may include a career, a providable special service content, sex, age, and the like of the care service provider.

When the cared person receives the information on the plurality of care service providers, selects a care service provider of his/her desired style, and transmits the selected provider to the care service management server 101, a care service providing time provided by the selected care service provider is determined.

The care service management server 101 may include a charge computing module 113 that computes the charge on the basis of a care service providing time and a care service providing item that are provided to the cared person, which are transmitted from the care service provider's terminal 107.

That is, after the care service provider provides the care service, the care service provider may transmit information for charge computation such as a service providing time and a service providing item to the care service management server 101 and the charge computing module 113 included in the care service management server 101 automatically computes the charge and transmits the computed charge to a predetermined charge requesting system. The charge computing module 113 receives information for computing charges of the plurality of care service providers and may integratively compute and request the charges.

The care service management server 101 may include a care management manual providing module 112 that provides a care management manual required to provide the care service to the care service provider to the care service provider's terminal 107.

The care management manual substitutes for provision recording paper and may include all manuals required to provide the care service.

The health condition management server 102 serves to provide a health condition management manual into which the health information for each hour and health information for each date of the cared person to the care service provider's terminal 107.

Therefore, by inputting and storing the health information for each hour and health information for each date of the cared person, it is possible to ensure fidelity in providing the care service and even though the care service provider is changed, it is possible to ensure service continuity by providing the health history of the cared person to the care service provider's terminal 107.

The learning contents management server 103 inputs and stores learning contents of the care service provider, and may provide them to the care service provider's terminal 107. The learning contents of the care service provider may be selected from a cared person play therapy content, cared person abuse prevention education contents, and care service provider continuing education contents. Contents for education of the care service provider are not limited thereto and any contents may be included.

The care service provider's terminal 107 is connected with the care service management server 101, the health condition management server 102, or the learning contents management server 103 to serve to transmit or receive predetermined information.

The care service provider's terminal 107 is preferably any one selected from a cellular phone, a smart phone, a portable multimedia player (PMP), a personal digital assistant (PDA), or electronic notebook which can transmit and receive data. Further, in order to ensure convenience in recording service contents, information is preferably inputted into the care service provider's terminal 107 by using a digital pen.

The cared person terminal 106 is connected with the care service management server 101 to serve to request the provision of the care service and receive the determined information and schedule of the care service provider and in this case, as the cared person's terminal 106, a cellular phone, a smart phone, a portable multimedia player (PMP), a personal digital assistant (PDA), or an electronic notebook which can transmit and receive data may be used.

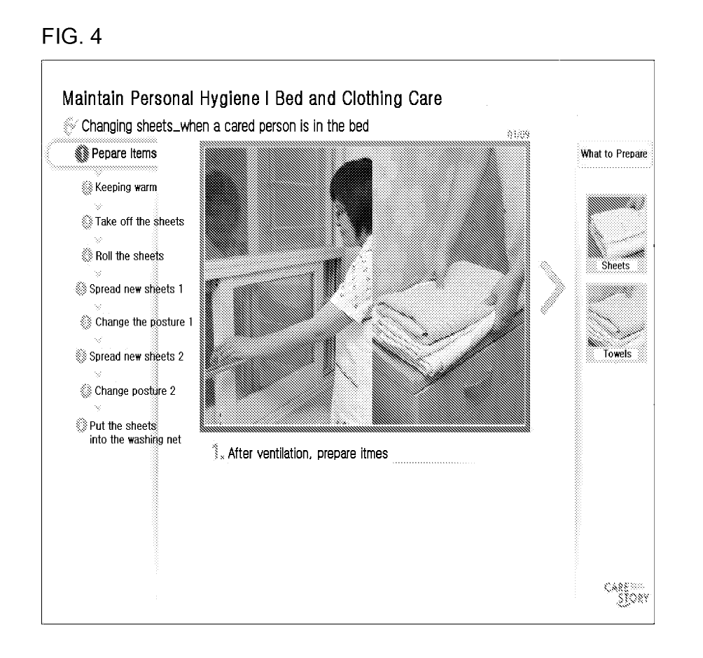

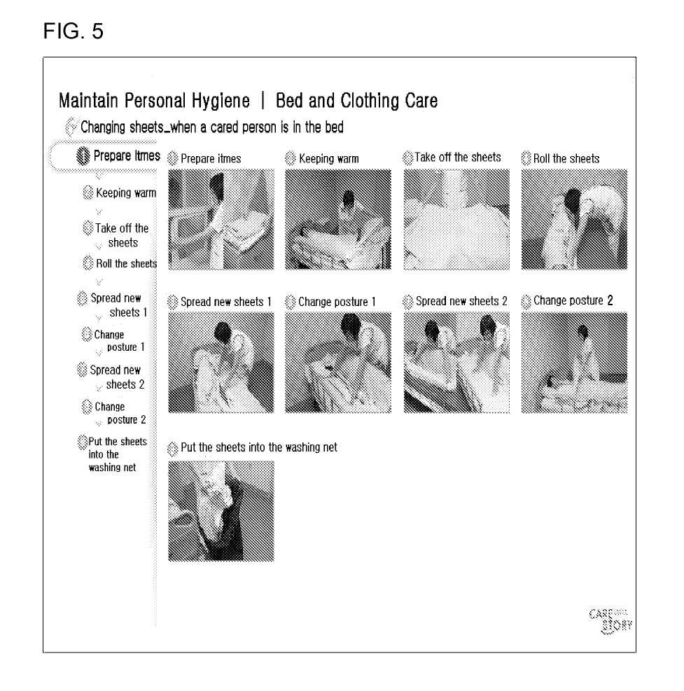

FIGS. 4 to 5 are exemplary diagrams of continuing education contents of care service providers according to an exemplary embodiment of the present invention.

In the prior art, since all teaching materials for the care service provider are not digital but learning tools, it is difficult to apply and utilize them on the spot.

That is, FIGS. 4 to 5 are examples of learning contents included in a learning contents management server. The learning contents include actual photographs, moving pictures, and stepwise description thereof (i.e., instruments to be prepared, notes, alternative products, and the like for each step) are included and provided to a care service provider's terminal to ensure the quality of a care service.

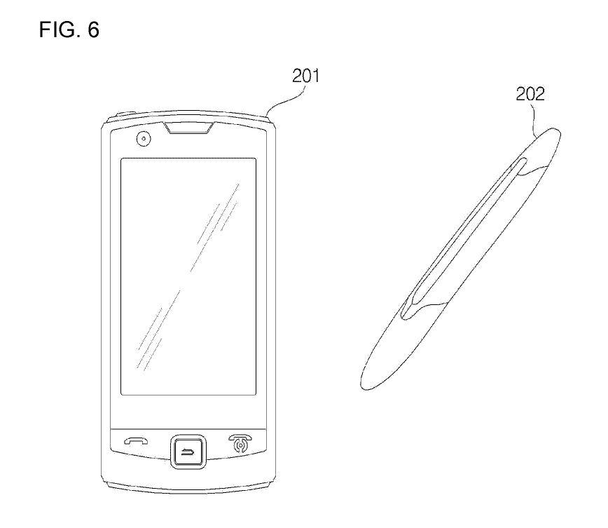

FIG. 6 is an exemplary diagram of a care service provider's terminal and a digital pen according to an exemplary embodiment of the present invention.

A care service provider's terminal 201 is connected with a care service management server, a health condition management server, or a learning contents management server to serve to transmit or receive predetermined information.

In FIG. 6, a smart phone is shown as one example, but the exemplary embodiment of the present invention is not limited thereto and the care service provider's terminal 201 may be formed by using a cellular phone, a portable multimedia player (PMP), a personal digital assistant (PDA), or an electronic notebook which can transmit and receive data. A digital pen 202 may be provided for recording rapidity, accuracy, and convenience.

The cellular phone, smart phone, portable multimedia player (PMP), personal digital assistant (PDA), or electronic notebook which can transmit and receive data preferably includes an RFID tag. This aims at providing a more rapid and complete service by facilitating location tracking of the care service provider.

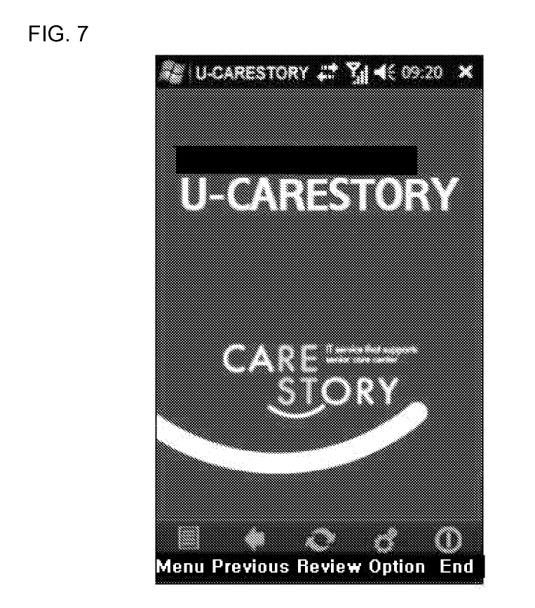

FIGS. 7 to 12 are screen display diagrams of a care service provider's terminal according to an exemplary embodiment of the present invention.

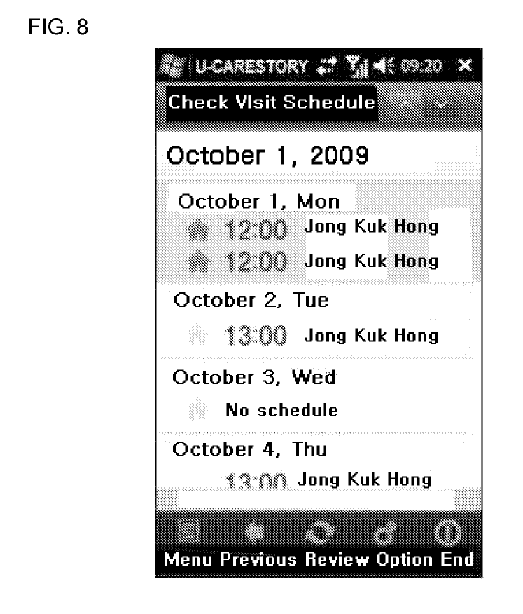

Referring to FIG. 8, it is possible to pursue service accuracy by providing schedule information for each date and cared person to the care service provider. Further, it is possible to pursue perfection in providing the service by rapidly providing even a schedule changed by the cared person.

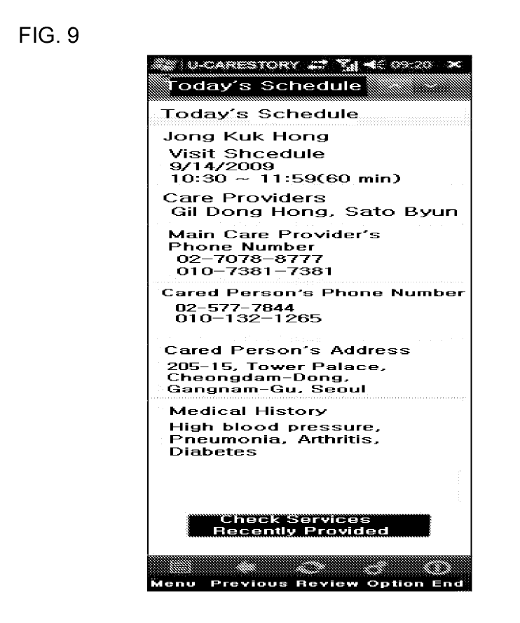

Referring to FIG. 9, a screen displaying information on the cared person is shown. That is, the care service provider verifies a visitation schedule, and a telephone number and an address of the cared person before visiting the cared person and verifies a disease history of the cared person to prepare a customized service.

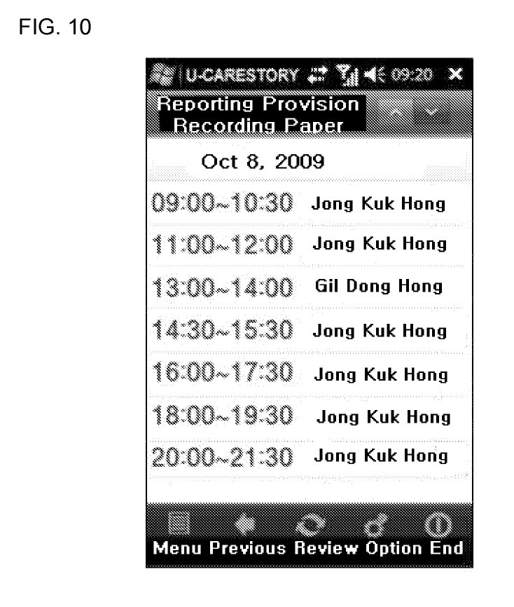

Referring to FIG. 10, a screen displaying whether or not a care management manual (provision recording paper) is reported is shown. It is possible to ensure rapidity, accuracy, and convenience in administrative processing by accurately recognizing whether or not a management manual for each care service time or for each care service item is reported.

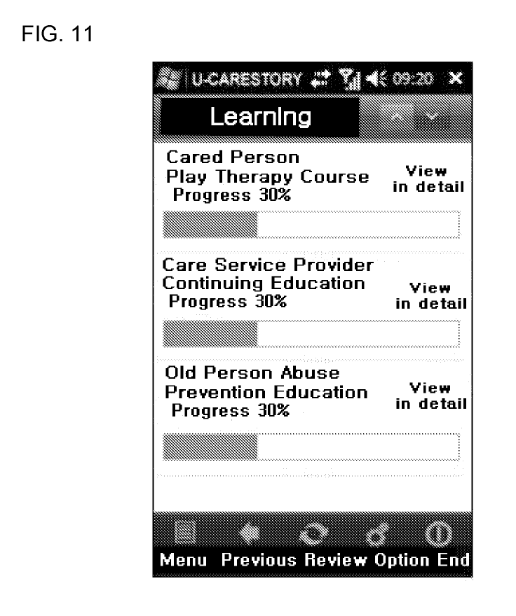

Referring to FIG. 11, the progress rate of a learning contents curriculum provided to the care service provider is shown. Allowing the care service provider to recognize the progress rate of the learning contents may contribute to the improvement of the care service.

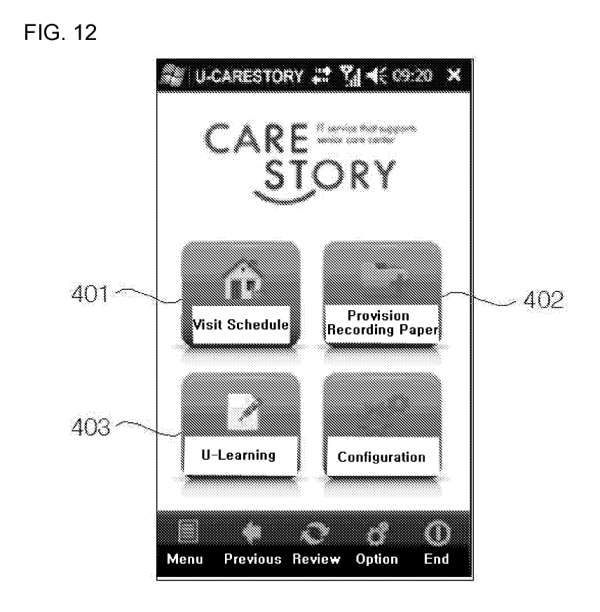

FIG. 12 shows a button to access a care service management server and a learning contents management server on a care service provider's terminal. The care service provider easily accesses the care service management server, the learning contents management server, and the health condition management server by using the care service provider's terminal to receive contents, and the like.

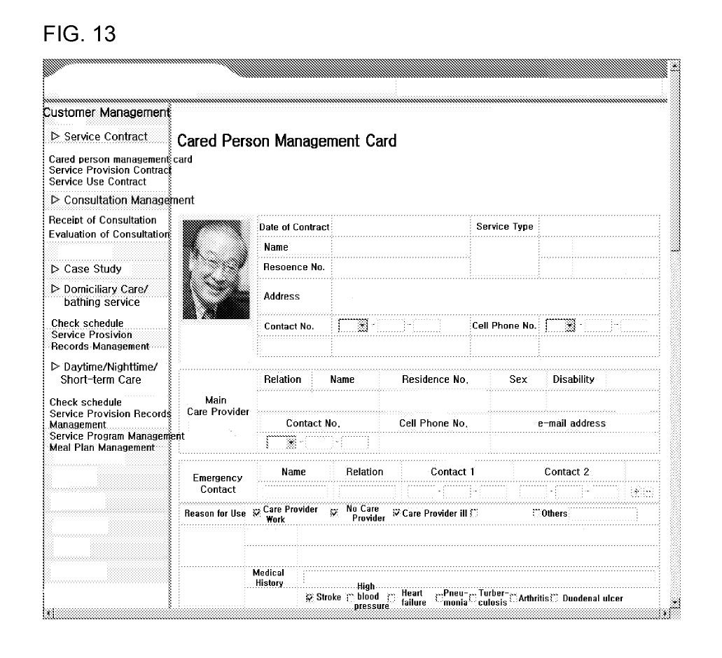

FIGS. 13 to 16 are exemplary diagrams of contents provided by a care service management system according to an exemplary embodiment of the present invention.

The contents shown in FIGS. 13 to 16 display a figure showing a screen of a computer connected with a central server of the care service management system, but may be provided to the care service provider's terminal as necessary.

FIG. 13 is a screen showing contents to record and manage various information of a cared person. That is, it is possible to provide a more complete care service by recording, updating, and managing information including a name, a telephone number, an e-mail address, and a past disease history of the cared person, a care service which the cared person desires, and the like.

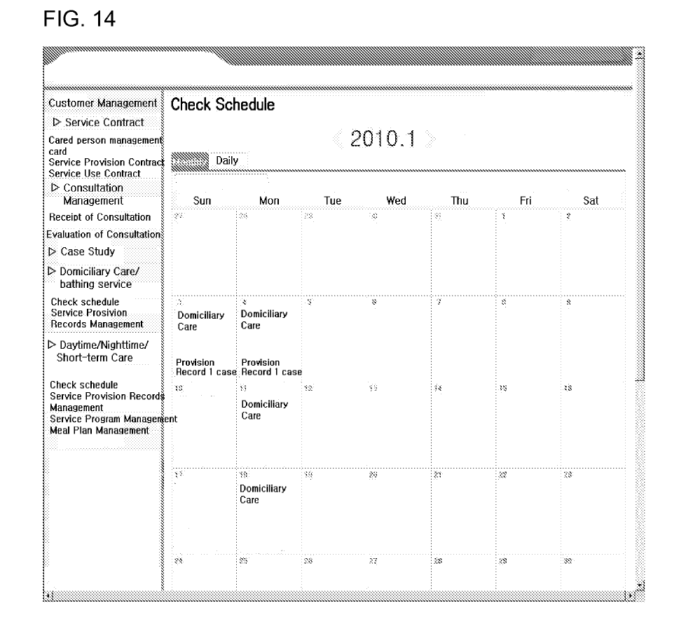

FIG. 14 is a screen showing contents to manage a care service schedule.

That is, a main computer connected with a central server of a care service institution may manage a care service schedule for each month, day, cared person, and care service provider. The care service schedule may be adopted in link with the care service provider's terminal.

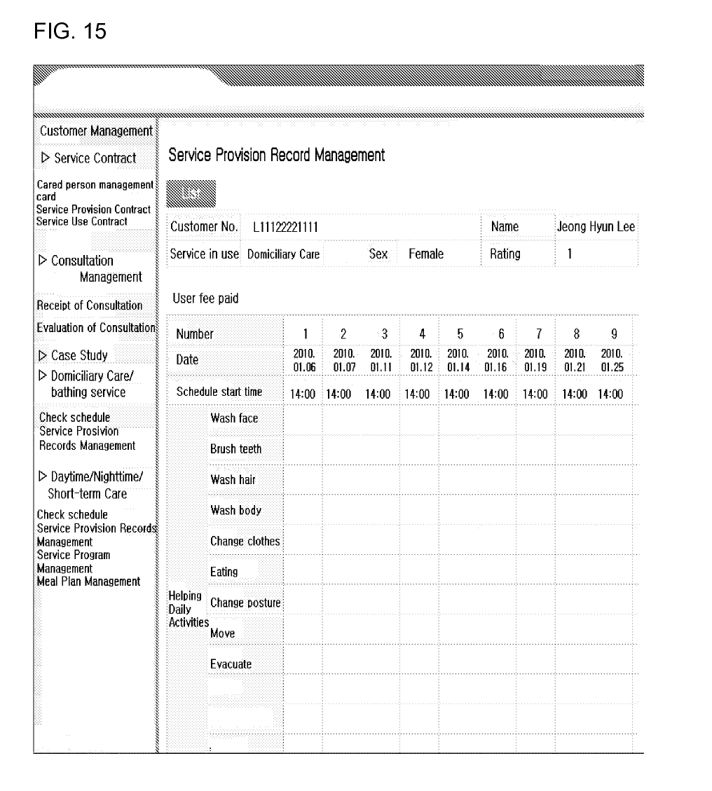

FIG. 15 is a screen showing contents to manage care service providing details.

The care service providing details (i.e., washing assistance, oral care, hair shampooing, body cleaning, body trimming, food assistance, movement assistance, excretion assistance, and the like) are managed for each month, day, cared person, and care service provider and on the basis of the managed details, the charge of the care service provider is computed.

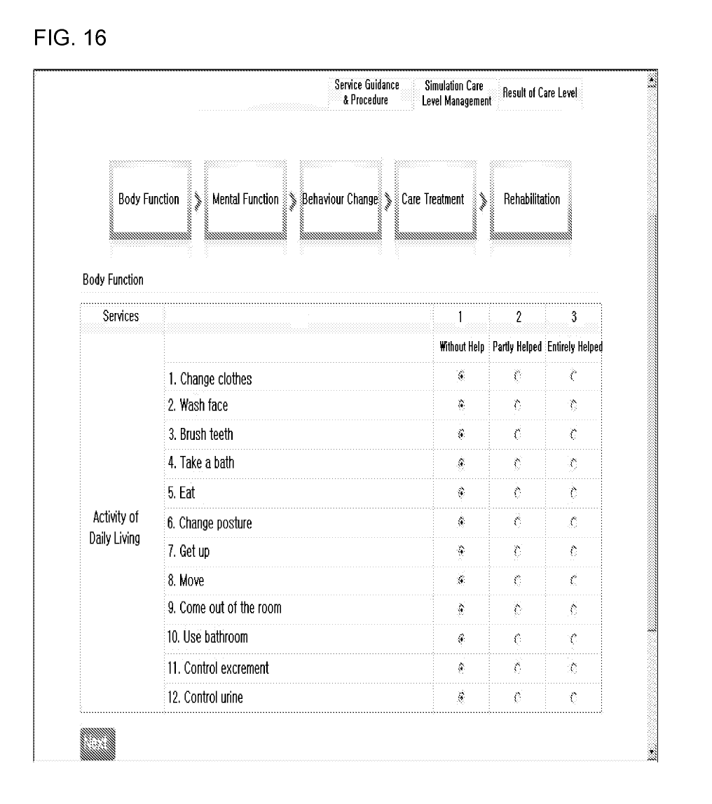

FIG. 16 is a screen displayed by a simulation care level judgment module which judges a care level by inputting predetermined health information of a cared person.

That is, a predetermined cared person checks items regarding the food assistance, movement assistance, excretion assistance, and the like to be subjected to the judgment of the care level and on the basis of the care level judgment, the corresponding cared person may request the care service. Therefore, it is possible to contribute to convenience promotion of the cared person.

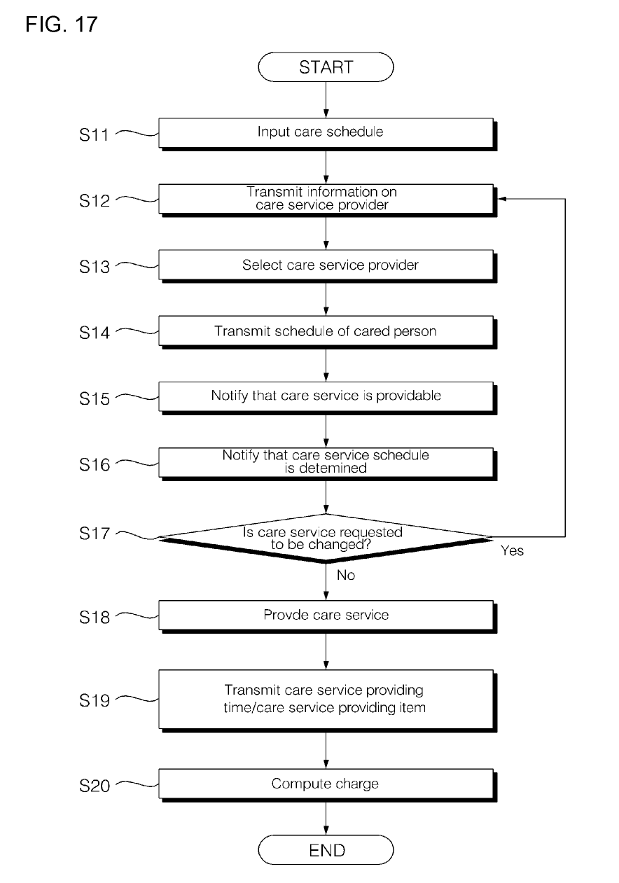

FIG. 17 is a flowchart of a care service management method according to an exemplary embodiment of the present invention.

First, a cared person inputs his/her desired care schedule into a care service management server by using a cared person's terminal (s11).

Thereafter, a schedule matching module of the care service management server transmits information on at least one care service provider having a schedule which matches the cared person's desired care schedule (s12). That is, the schedule matching module refers to a service request time, a past disease history, a care level, and the like of the cared person to transmit information on a plurality of care service providers who are suitable therefor.

Subsequently, the cared person selects his/her desired care service providers among at least one care service provider (s13) and the care service management server transmits a cared person's schedule to a care service provider's terminal of the care servicer provider selected by the cared person (s14).

The care service provider who receives the cared person's schedule notifies that the care service can be provided in accordance with the cared person's schedule to the care service management server (s15) and the care service management server notifies that the care service schedule is determined to the cared person's terminal (s16).

Therefore, before receiving the care service, it is judged whether or not the cared person requests the change of the care service in the care service management server (s17).

If the cared person requests the change of his/her schedule or the selected care service provider, the care service schedule is redetermined through steps s12 to s16.

However, if the cared person does not request the change of the care service, the care service provider provides the care service (s18).

Thereafter, when the care service provider transmits a care service providing time and a care service providing item to the care service management service (s19) and a charge computing module of the care service management server computes a charge on the basis of the care service providing time and the care service providing item (s20), the care service management method of the exemplary embodiment of the present invention is completed.

At the providing of the care service (s18) according to the exemplary embodiment of the present invention, (1) at least one content selected from a cared person play therapy content, a cared person abuse prevention education content, and a care service provider continuing education content included in a learning contents management server may be provided to the care service provider's terminal. (2) Further, a care management manual providing module of the care service management server provides a care management manual required to provide a care service to the care service provider's terminal to provide convenience in recording a care service providing item, a care service providing time, and the like. (3) In addition, a health condition management server provides a health condition management manual for inputting health information for each hour and health information for each date of the cared person into the care service provider's terminal to thereby improve the quality of consecutive care services.

The present invention may include a computer-readable recording medium in which a computer program for executing the care service management method is recorded.

While the present invention has been described with reference to the preferred embodiments, it will be understood by those skilled in the related art that various modifications and variations may be made therein without departing from the scope of the present invention as defined by the appended claims.

1. A care service management system for a care service provider and a cared person, comprising:
a care service management server inputting and storing a cared person information DB, a care service provider information DB, a cared person schedule DB, a care service provider schedule DB, and a charge information DB;
a health condition management server inputting and storing health information for each hour/date of the cared person;
a learning content management server inputting and storing learning contents of the care service provider;
a cared person's terminal connected with the care service management server to request for providing the care service and receive the determined information and schedule of the care service provider; and
a care service provider's terminal connected with the care service management server, the health condition management server, or the learning contents management server to transmit or receive predetermined information.

2. The system of claim 1, further comprising a simulation care level judgment server equipped with a simulation care level judgment module that judges a care level by inputting predetermined health information of the cared person.

3. The system of claim 1, wherein the cared person information DB includes an address, a telephone number, an e-mail address, and a disease history of the cared person.

4. The system of claim 1, wherein the care service management server includes a schedule matching module that matches a schedule when the cared person wants to be cared for and a schedule of the care service provider which the cared person requires.

5. The system of claim 1, wherein the care service management server includes a charge computing module that computes the charge on the basis of a care service providing time and a care service providing item that are provided to the cared person, which are transmitted from the care service provider's terminal.

6. The system of claim 1, wherein the care service management server includes a care management manual providing module that provides a care management manual required to provide the care service to the care service provider to the care service provider's terminal.

7. The system of claim 1, wherein the health condition management server provides a health condition management manual into which the health information for each hour and health information for each date of the cared person to the care service provider's terminal.

8. The system of claim 1, wherein the learning contents of the care service provider is at least one selected from a cared person play therapy content, cared person abuse prevention education contents, and care service provider continuing education contents.

9. The system of claim 1, wherein the care service provider's terminal is any one selected from a cellular phone, a smart phone, a portable multimedia player (PMP), a person digital assistant (PDA), and an electronic notebook which can transmit and receive data.

10. The system of claim 9, wherein information is inputted into the care service provider's terminal by using a digital pen.

11. A care service management method for a care service provider and a cared person, comprising:
(a) allowing a cared person to input a care schedule which the cared person desires into a care service management server by using a cared person's terminal;
(b) allowing a schedule matching module of the care service management server to transmit information on at least one care service provider having a schedule matching the care schedule which the cared person desires to the cared person's terminal;
(c) allowing the cared person to select his/her desired care service provider from at least one care service provider;
(d) allowing the care service management server to transmit the schedule of the cared person to a care service provider's terminal of a care service provider selected by the cared person;
(e) allowing the care service provider receiving the schedule of the cared person to notify that the care service is providable in accordance with the schedule of the cared person to the care service management server;
(f) allowing the care service management server to notify that the care service schedule is determined to the cared person's terminal; and
(g) providing the care service by the care service provider.

12. The method of claim 11, further comprising: after step (g),
(h) allowing the care service provider to transmit a care service providing time and a care service providing item to the care service management server; and
(i) allowing a charge computing module of the care service management server to compute a charge on the basis of the care service providing time and the care service providing item.

13. The method of claim 11, further comprising: after step (f),
(j) allowing the cared person to request for the change of the care service to the care service management server;
(k) allowing the schedule matching module of the care service management server to transmit information on at least one care service provider which is suitable for the changed schedule to the cared person's terminal;
(l) allowing the cared person to select his/her desired care service provider;
(m) allowing the care service management server to transmit the schedule of the cared person to the care service provider's terminal;
(n) allowing the care service provider receiving the schedule of the cared person to notify that the care service is providable in accordance with the schedule of the cared person to the care service management server; and
(o) allowing the care service management server to notify that the schedule is determined to the cared person's terminal.

14. The method of claim 11, wherein at step (k), the schedule matching module complexly modifies schedules of a plurality of care service providers to form an optimal schedule of the care service provider and transmits the formed schedule to the cared person's terminal.

15. The method of claim 11, wherein at step (g), at least one content selected from a cared person play therapy content, a cared person abuse prevention education content, and a care service provider continuing education content included in a learning contents management server is provided to the care service provider's terminal.

16. The method of claim 11, wherein at step (g), a care management manual providing module of the care service management server provides a care management manual required to provide the care service to the care service provider's terminal.

17. The method of claim 11, wherein at step (g), a health condition management server provides a health condition management manual to input health information for each hour and health information for each date to the care service provider's terminal.

18. The method of claim 11, wherein the care service provider's terminal is any one selected from a cellular phone, a smart phone, a portable multimedia player (PMP), a personal digital assistant (PDA), and an electronic notebook which transmits and receives data.

19. The method of claim 18, wherein information is inputted into the care service provider's terminal by using a digital pen.

20. A computer-readable recording medium recording a computer program for executing a method according to claim 11.
